(19) United States
(12) Patent Application Publication
(10) Pub. No.: US 2022/0309548 A1
(43) Pub. Date: Sep. 29, 2022

(54) METHOD FOR MANAGING REVIEW AND SYSTEM THEREOF

(71) Applicant: INDENT CORP. Co., Ltd., Seongdong-gu, Seoul (KR)

(72) Inventors: Tae Seok Yoon, Seongdong-gu, Seoul (KR); Gyun Ho Park, Songpa-gu, Seoul (KR)

(73) Assignee: INDENT CORP. Co., Ltd., Seongdong-gu, Seoul (KR)

(21) Appl. No.: 17/431,753

(22) PCT Filed: Apr. 11, 2020
(86) PCT No.: PCT/KR2020/004922

§ 371 Date: Aug. 18, 2021

(30) Foreign Application Priority Data
Mar. 16, 2020 (KR) 10-2020-0032303

(51) Int. Cl. G06Q 30/02

(52) U.S. Cl. CPC G06Q 30/0282; G06Q 30/0201

(57) ABSTRACT

Disclosed is a review management system based on a chatbot. The review management system includes an information reception unit configured to receive product purchase information of a user from at least one sales server, a checking unit configured to monitor delivery information of the purchased product in real time, a chatbot execution unit configured to establish a channel through which a chatbot is able to communicate with the user when a preset period elapses after the checking unit checks delivery completion, and request the user to upload a review of a corresponding product, and a review posting unit configured to post a review on a review page when the user uploads the review on the channel. According to an embodiment of the present disclosure, it is possible to expect for an individual user to positively upload a review by providing a personalized chatbot interface to the user.

### BACKGROUND

### 1. Technical Field

The present disclosure relates to a method of managing a review, and more particularly, to a method of managing a review, which is configured to accurately identify a user purchasing a product through a chatbot even in any environment, provide the user with information on the purchased product through chatting, and enable the user to easily upload a review of the product.

### 2. Related Art

In a conventional market, purchase decisions of consumers tend to depend on recommendations of acquaintances or word-of-mouth, and such a tendency appears in a way to depend on reviews of products of others in an online market, that is, online reviews. In such an online market environment, a consumer generally decides to purchase a product based on reviews of other consumers for the product posted on a product page, in addition to product information posted by a seller, because the consumer cannot directly check the product.

Positive reviews of other consumers for a product stimulate a consumer's purchase need and significantly affect the purchase of the product. Accordingly, marketing is prevailing, which raises a product purchase rate by tampering with multiple good product reviews on a product purchase page.

However, in a conventional online shopping system, users are reluctant to leave reviews or easily forget to leave reviews over time because a review has to be posted on a product purchase page of each shopping mall. Accordingly, there are lots of cases where very few of all users write reviews or a list of reviews is plastered with advertising reviews. In such an environment, a review system is left unattended without achieving an original purpose of raising a purchasing rate or sharing honest impressions of consumers for a product.

Furthermore, such an environment has problems in that an actual user's opportunity to share his or her honest impression for a product is partially deprived and consumers are more frequently exposed to advertising reviews, not reviews of actual users.

Korean Patent Application Publication No. 10-2017-0116359 discloses a system and method for a real review. An object of the system for a real review is to raise reliability of reviews and posting for a must-eat place or a store. The system blocks a false review by a nonshopper in a way to assign a code to a receipt issued to a visitor who actually uses a store and to identify the code when the visitor obtains rights to post a review.

However, such a review system using receipt information still relies on the upload of a review based on a spontaneous intention of a consumer, and does not provide a consumer with a platform which enables the consumer to easily post a review. That is, such a system merely serves to filters an improved review for a seller, and is not an invention that enables a consumer to easy post a review.

Furthermore, the system is a system for determining whether to permit a review of a single store, and still has a difficulty in checking a purchase history of various stores.

If a user uses a command conventional online review system, the user needs to post a review for each shopping mall. Accordingly, if the user does not positively post a review at the time of purchasing a product or in the near future after the purchase, the probability that the user will post a review is very low. Furthermore, if the user purchases a plurality of articles in a plurality of shopping malls, it is difficult for the user to remember what product was purchased in which shopping mall. Even, it becomes more difficult for the user to post a review over time if the shopper forgets an ID and password of a specific shopping mall.

Furthermore, conventionally, a chatbot is commonly used in various services, however, some messengers cannot specify a user who provided an answer to a first message of the chatbot because user information is randomized when a channel is established after the chatbot sent the first message. Accordingly, there is a problem in that a conventional service using a chatbot must directly receives personal information from the user in order to identify the user. That is, the conventional service using a chatbot does not provide a personalized service, but merely provides only common services.

### SUMMARY

Various embodiments are directed to providing a review system based on a chatbot, which includes a chatbot capable of automatically communicating with a consumer by using a chatting application commonly used by consumers and increases accessibility of review upload in a way that the chatbot establishes a channel when the delivery of a purchase product or the provision of a purchase service is completed, requests a review of a product purchased by a consumer, and receives the upload of the review through the channel.

Technical objects to be achieved by the present disclosure are not limited to the aforementioned object, and may include various technical objects within a range evident to those skilled in the art from contents to be described hereinafter.

In an embodiment, a review management system based on a chatbot includes an information reception unit configured to receive product purchase information of a user from at least one sales server, a checking unit configured to monitor delivery information of the purchased product in real time, a chatbot execution unit configured to establish a channel through which a chatbot is able to communicate with the user when a preset period elapses after the checking unit checks delivery completion, and request the user to upload a review of a corresponding product, and a review posting unit configured to post a review on a review page when the user uploads the review on the channel. The product includes a service, the delivery information is service execution information when the product is a service, and the delivery completion is service execution completion.

In an embodiment, the review management system further includes a generation unit configured to obtain user information from the product purchase information and generate a query sign that specifies the user and an identification indicator corresponding to the query sign. The chatbot execution unit identifies the user based on the identification indicator, and requests the user to upload the review of the corresponding product through the chatbot by outputting the query sign and the identification indicator to a channel of a user terminal when the preset period elapses after the checking unit checks the delivery completion.

In an embodiment, the chatbot execution unit directly or indirectly transmits, to the channel, a notification message including the query sign when the checking unit checks the delivery completion, wherein the chatbot execution unit outputs a message of the user including the identification indicator when the message of the user is input to the channel after the notification message is transmitted to the channel, and requests the user to upload the review of the corresponding product by inquiring about the product purchase information of the user corresponding to the identification indicator.

In an embodiment, the identification indicator is identical with the query sign.

In an embodiment, each of the query sign and the identification indicator is any one of a plurality of pieces of partial information constituting the product purchase information or a combination of the plurality of pieces of partial information.

In an embodiment, a method of managing a review based on a chatbot includes receiving product purchase information of a user from at least one sales server, monitoring delivery information in real time, establishing a channel through which a chatbot is able to communicate with the user when a preset period elapses after delivery completion is checked, and requesting the user to upload a review of a corresponding product, and posting a review on a review page when the user uploads the review on the channel. The product includes a service, the delivery information is service execution information when the product is a service, and the delivery completion is service execution completion.

In an embodiment, the method further includes obtaining user information from the product purchase information and generating a query sign that specifies a user and an identification indicator corresponding to the query sign. The requesting of the user to upload the review includes identifying the user based on the identification indicator and requesting the user to upload the review of the corresponding product through the chatbot by outputting the query sign and the identification indicator to a channel of a user terminal when the preset period elapses after the delivery completion is checked.

In an embodiment, the requesting of the user to uploading the review includes directly or indirectly transmitting, to the channel of the user terminal, a notification message including the query sign when the preset period elapses after the delivery completion is checked, outputting a message of the user including the identification indicator to when the message of the user is input to the channel after the notification message is transmitted to the user terminal, and requesting the user to upload the review of the corresponding product by inquiring about the product purchase information of the user corresponding to the identification indicator.

In an embodiment, the identification indicator is identical with the query sign.

In an embodiment, each of the query sign and the identification indicator is any one of a plurality of pieces of partial information constituting the product purchase information or a combination of the plurality of pieces of partial information.

According to an embodiment of the present disclosure, it is possible for an individual user to positively by providing a personalized chatbot interface to the user.

According to an embodiment of the present disclosure, the review system can specify an individual user even in a messenger in which a message of the user is randomized because the chatbot leaves a unique identification indicator for the user in a messenger channel.

According to an embodiment of the present disclosure, since a user can be easily specified, a past shopping history in many shopping malls used by an individual user can be presented at a time through a messenger channel.

### BRIEF DESCRIPTION OF THE DRAWINGS

FIG. 1 is a diagram for describing interactions between a review management system based on a chatbot according to an embodiment of the present disclosure and external devices.

FIG. 2 is a diagram for describing a sequence in which the review management system based on a chatbot according to an embodiment of the present disclosure operates.

FIG. 3 is a diagram illustrating that modules of the review management system based on a chatbot according to an embodiment of the present disclosure are divided.

FIG. 4 is a diagram illustrating a process of exchanging, by the review management system based on a chatbot according to an embodiment of the present disclosure, data with external devices.

FIG. 5 is a diagram illustrating a process of exchanging, by a review management system based on a chatbot according to an embodiment different from the embodiment of FIG. 4, data with external devices.

FIG. 6 is a diagram illustrating a process of exchanging, by the review management system according to the embodiment of FIG. 5, data with a messenger server and a user terminal in order to identify a user.

FIG. 7 is a diagram illustrating a part of a chatbot interface according to an embodiment of the present disclosure.

### DETAILED DESCRIPTION

The aforementioned and additional aspects of the present disclosure are embodied through embodiments described with reference to the accompanying drawings. However, embodiments described hereinafter are merely illustrative, and are not intended to limit the scope of the present disclosure to only described embodiments. Furthermore, elements of each of the embodiments may have various combinations within one embodiment or among embodiments unless they are described otherwise or they contradict each other.

Furthermore, when it is described that any part “includes (or comprises)” an element, this will be understood to imply the inclusion of a stated element regardless of other elements, but not the exclusion of a possibility that any other elements will be included.

Furthermore, throughout the specification, when it is described that any part is “connected” to another part, the any part is “directly connected” to the another part or “indirectly (or electrically) connected” to the another part with a third element interposed therebetween.

Furthermore, in the entire specification, when it is described that any information is “transmitted”, it will be understood that the any information is “directly transmitted” or “indirectly (or secondarily) transmitted” through a third element.

Furthermore, in the entire specification, some of an operation or function described as mapping or matching with a terminal may be interpreted as a meaning that a unique number or personal identification information of the terminal, that is, identifying data of the terminal, is mapped or matched.

Furthermore, in the entire specification, a product may include various forms which may be purchased online, such as delivery food, a rental product and a service, in addition to goods.

Hereinafter, the present disclosure is described in detail with reference to the accompanying drawings.

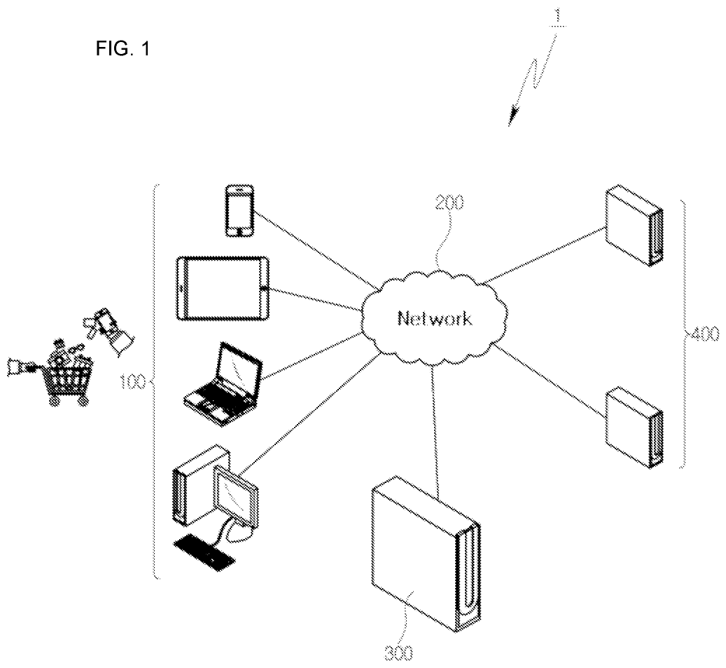

FIG. 1 is a diagram for schematically describing interactions between a review management system based on a chatbot according to an embodiment of the present disclosure and external devices.

Referring to FIG. 1, a review management system 300 interacts with a user terminal 100 and at least one sales server 400 over a network 200.

Referring to FIG. 1, a user may purchase a product in the at least one sales server 400 by using the user terminal 100, may receive the product, and may upload a review of the purchased product through a channel of a messenger through which a chatbot provided by the review management system 300 accesses the user. In this case, the channel is a space established by a messenger server 700 so that the user and a review manager can chat with each other. The channel includes at least a chat room, and may include broadly a resource allocated to the messenger server 700 for a dialogue between two subjects.

That is, the review management system 300 or the chatbot provided by the review management system 300 requests the establishment of the channel with the user from the messenger server 700. The messenger server establishes a dialogue channel between the user and the chatbot. The chatbot may inquire about a purchase history of various products in a plurality of shopping malls when the user is identified, and show the purchase history to the user. The user may select any one of products whose delivery has been completed, and may upload a review of the product on the channel. In this case, the user can check the past purchase history, and may upload a review of a product purchased in the past or may purchase the product again.

In an embodiment of the present disclosure, the user terminal 100 may be implemented as a computer capable of accessing a server or terminal at a remote place over a network or a wireless communication device having guaranteed portability and mobility.

The review management system 300 may receive product order information from the multiple sales servers 400, that is, affiliation shopping mall servers, in real time. Specifically, when a user orders a product from at least one shopping mall and the ordered product is released, the review management system 300 may receive product order information from the sales server 400 in real time, and may receive delivery completion information from the sales server 400 or a separate delivery information server 800. In this case, in the present disclosure, the product does not mean only goods. If the product is a service or delivery food, it is evident that those skilled in the art may understand that the review management system 300 receives information on service execution completion from the delivery information server 800 in real time.

The product order information may include an orderer name, delivery information, an order number, the name of a shopping mall from which the product was purchased, a hosting company, etc.

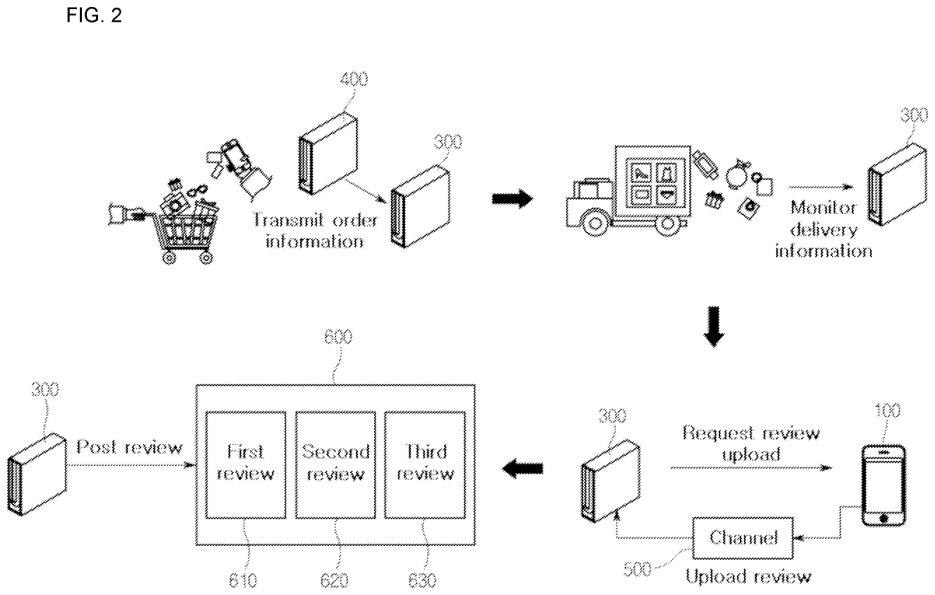

FIG. 2 is a diagram for describing a sequence in which the review management system based on a chatbot according to an embodiment of the present disclosure operates.

A user orders a product on a product page of a shopping mall by using the user terminal 100. A server of the shopping mall, that is, the sales server 400, is one of multiple affiliation shopping mall sales servers, and transmits product order information to the review management system 300 in real time.

The review management system 300 continuously monitors delivery information. When the review management system 300 obtains information indicating that delivery has been completed, the review management system 300 or a chatbot driven by the review management system 300 requests the establishment of a channel from the messenger server 700. When the chatbot transmits, to the user, a message that requests review upload through a messenger installed in the user terminal 100, the user may conveniently upload a review on the channel through the user terminal 100.

The review management system 300 may post, on a review page 600, reviews uploaded as described above. The review page 600 is constructed so that many reviews, such as a first review 610, a second review 620 and a third review 630 including experiences of various consumers are exposed.

In an embodiment of the present disclosure, the review management system 300 and one sales server 400 may be operated by the same subject. For example, if a specific shopping mall company owns its server and operates the review management system 300 in the server by introducing the review management system 300, customers who use a shopping mall of the shopping mall company can directly experience a chatbot interface according to an embodiment of the present disclosure.

In an embodiment of the present disclosure, the review management system 300 and multiple sales servers 400 may be operated by different subjects.

In FIG. 2, the review page 600 may be composed in a widget form, and is matched with each product in each shopping mall affiliated with the review management system 300 and exposed to consumers.

The review page 600 may be produced and operated by the review management system 300, but the present disclosure is not essentially limited thereto. The review page 600 may be produced and operated by a review page-dedicated operator or shopping mall.

Each of the first review 610, the second review 620 and the third review 630 displayed on the review page 600 may be any one of a moving picture, characters, and an image.

The first review 610 may be an experience of a first user, the second review 620 may be an experience of a second user, and the third review 630 may be an experience of a third user.

When the delivery of a released product is completed, the review management system 300 may check the delivery completion. After a lapse of a preset period, the chatbot may establish a messenger channel in the user terminal. The preset period includes the moment when delivery is completed, and may mean a time section of a minute, hour, or day unit after delivery completion, for example.

When the user terminal 100 accesses the channel, the review management system 300 may identify the user and may inquire about product order information corresponding to the user. The product order information is information received in real time from the at least one sales server 400, preferably, servers of various shopping malls, and may include a variety of types of information, such as an orderer name, a product name, a shopping mall name, destination information, an order number, and a hosting company name. That is, regardless of shopping malls, that is, sources of various products purchased by one user, and the time when a product was purchased, if the product is a product purchased in a shopping mall affiliated with the review management system 300, the review management system 300 may inquire about product order information.

The review management system 300 may inquire about even order information related to a product whose delivery was completed in the past among pieces of inquired product order information, and may transmit a corresponding list to the user terminal by using the chatbot. The user may select any one product in the list, and may directly upload at least any one of text, an image and a video on the channel.

Furthermore, the review management system 300 may receive, from the messenger server 700, a review uploaded on the channel, may post the review on the review page, and may associate the at least one sales server 400 and the review page so that the review posted on the review page is exposed to a corresponding product page of a shopping mall that operates the at least one sales server 400.

In this case, the review page 600 may be provided on some of a product page of each shopping mall in a widget form and may be produced and operated by the review management system 300, but the present disclosure is not limited thereto.

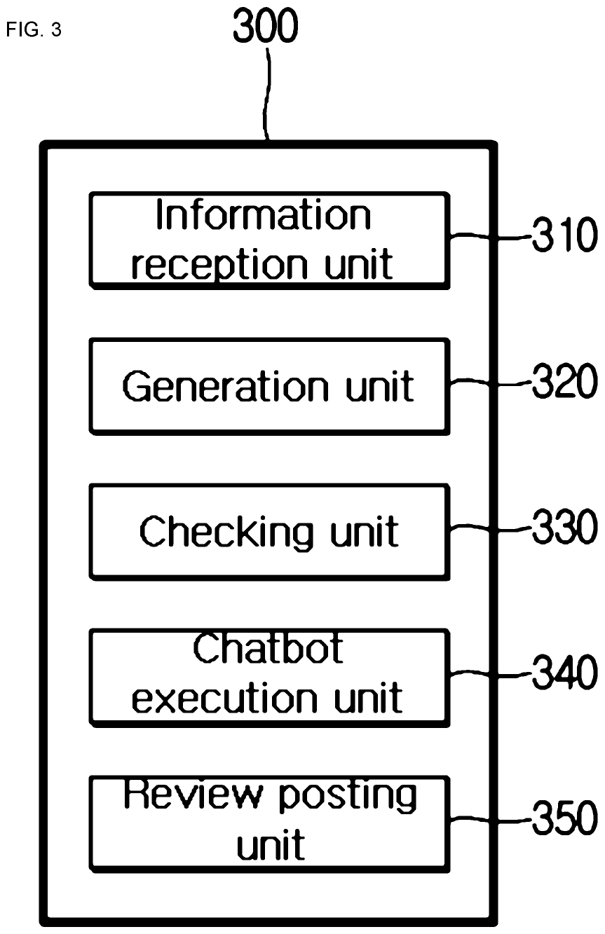

FIG. 3 is a diagram illustrating that modules of the review management system based on a chatbot according to an embodiment of the present disclosure are divided. Referring to FIG. 3, the review management system 300 may include an information reception unit 310, a generation unit 320, a checking unit 330, a chatbot execution unit 340 and a review posting unit 350.

The information reception unit 310 may receive product purchase information of a user from the at least one sales server 400. The information reception unit 310 may receive new product purchase information from the sales servers 400 in real time. When the information reception unit 310 receives product purchase information of a first product, the review management system 300 may inquire about all products including a second product, a third product and an n-th product purchased by the user. That is, when the information reception unit 310 receives the product purchase information of the first product, the review management system 300 may inquire about all of histories in which the user purchased products in shopping malls, that is, purchasing places of the products purchased by the user. Inquiry about information on the past purchase history may be performed after the first product is purchased. However, information previously inquired about prior to the purchase of the first product and stored in a database used by the review management system 300 may be inquired about again because the review management system 300 and the at least one sales server 400 communicate with each other in real time.

The generation unit 320 may obtain user information from the product purchase information. When the user information is obtained, the generation unit 320 may request the establishment of a channel with the user, and may transmit a required request message.

However, in the case of a messenger in which a user ID is randomized and transmitted among online messengers, when a channel is established, although the establishment of the channel is requested from the messenger server 700 by using a telephone number or user ID of a user, a manager of the review management system 300 cannot specify who the user is because the user ID is randomized and transmitted after the establishment of the channel.

Accordingly, the review management system 300 based on a chatbot according to an embodiment of the present disclosure includes the generation unit 320. The generation unit 320 may generate a query sign that specifies a user and an identification indicator corresponding to the query sign.

The use of the query sign and the identification indicator are described in detail later.

The checking unit 330 may monitor delivery information of a purchased product in real time. The checking unit 330 may receive a tracking number and inquire about a delivery state in real time or may directly receive “delivery completion” information from a delivery information server 800. The delivery information server 800 may be a separate server, but may be an element included in the review management system 300.

In an embodiment, after delivery completion is checked, when a preset period elapses, the chatbot execution unit 340 may instruct a chatbot to establish a channel with a user. The preset period may be the moment immediately after the completion of the delivery or after some time from the delivery completion.

When the preset period elapses after the checking unit 330 checks the delivery completion, the chatbot outputs the query sign and the identification indicator to the channel of the user terminal, such that the chatbot execution unit 340 may identify the user based on the identification indicator.

Specifically, when the checking unit 330 checks the delivery completion, the chatbot execution unit 340 may directly or indirectly transmit, to the channel, a notification message including the query sign.

After the notification message is transmitted to the channel, when a message of the user is input to the channel, the chatbot execution unit 340 may output the message of the user including the identification indicator.

When recognizing the user information or the identification indicator, the chatbot execution unit 340 may output, to the channel, a list of products whose delivery has been completed among product order information that is mapped to the user and stored. For example, if a customer A has purchased products a, b, c and d in shopping malls B, C, D and E, respectively, and the delivery of all the products has been completed, the chatbot execution unit 340 may show all the products to the customer A in a list form. Furthermore, the customer A may select which product the customer A will review. Although the customer A has purchased a product in any shopping mall in the past, the customer A can determine the selection of a review of the product in one channel and upload the review. Accordingly, frequency of review uploads of the customer A rises.

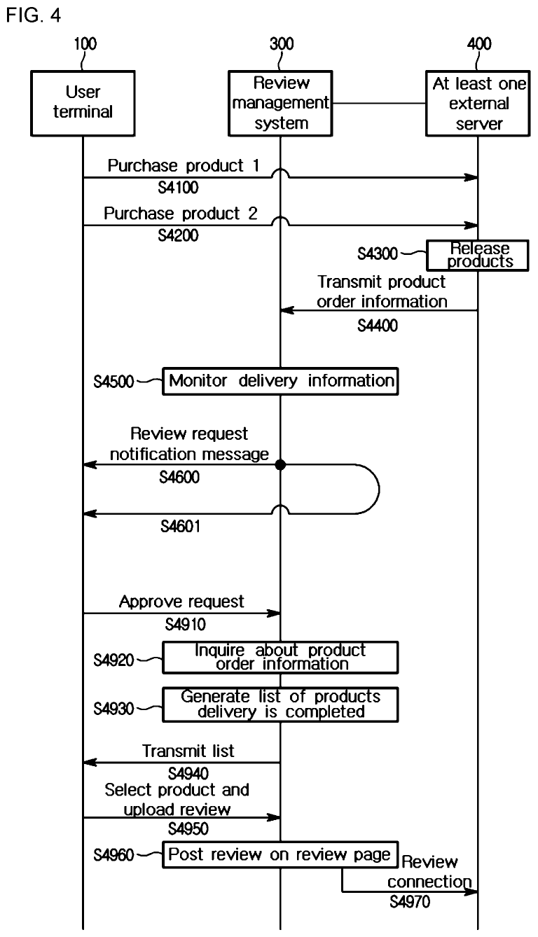

FIG. 4 is a diagram illustrating a process of exchanging, by the review management system based on a chatbot according to an embodiment of the present disclosure, data with external devices, and illustrates the case of a messenger which does not randomize a user ID.

A manager of the review management system may request a user to upload a review based on common connection information, such as a user ID or a telephone number. When the user purchases a first product and a second product in a shopping mall having the at least one sales server 400 by using the user terminal 100 (S4100, S4200), the shopping mall releases the products (S4300). The at least one sales server 400 transmits product order information to the review management system 300 (S4400).

The review management system 300 always monitors delivery information (S4500). When the delivery of the products is completed, the review management system 300 transmits a review request notification message to the user (S4600). The review management system 300 may directly transmit the review request notification message to the user terminal 100 through the messenger server 700, but the review management system 300 may request another organization to transmit the review request notification message to the user terminal 100 (S4601).

The user may check the review request notification message in a messenger executed in the user terminal 100, and may determine whether to approve the review request. When the user approves the review request (S4910), the review management system 300 inquires about the product order information of the ordered products (S4920), also generates a list of purchase products purchased by the user and completely delivered in the past (S4930), and transmits the list to the user terminal 100 (S4940).

The user may check the purchased products in the messenger channel, may select a product including corresponding data to be shared if a recorded moving picture or photo of the corresponding product is present, and may upload the data as a review of the corresponding product (S4950). Furthermore, the user may upload a photo, a moving picture, or text as a review of a product on the spot in addition to the existing recorded data.

When the user uploads the review on the messenger channel 500, the review management system 300 posts the review on the review page 600 (S4960). The review may operate in conjunction with a shopping mall product purchase page or a page having a given form in which the review can be checked so that the review is exposed to the shopping mall product purchase page or the page having a given form (S4970).

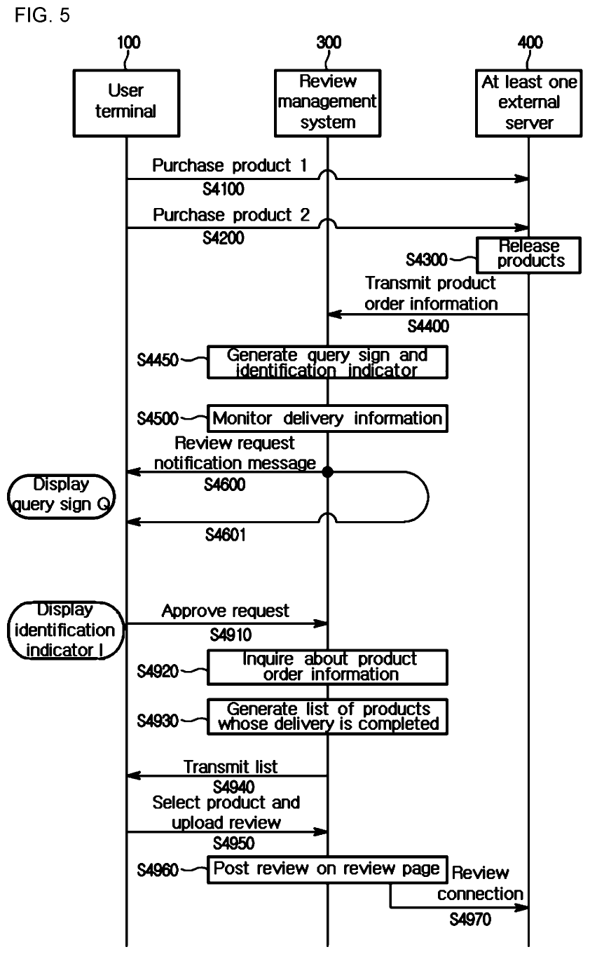

FIG. 5 is a diagram illustrating a process of exchanging, by the review management system based on a chatbot according to an embodiment different from embodiment of FIG. 4, data with external devices.

Referring to FIG. 5, the generation unit 320 of the review management system 300 may generate a query sign Q and an identification indicator I (S4450). The query sign Q and the identification indicator I are information corresponding to a user, and are stored in a database of the review management system 300.

After receiving product order information (S4400), the review management system 300 monitors delivery information of a corresponding product (S4500). When the checking unit 330 receives delivery completion information, the review management system 300 transmits a review request notification message to the user terminal 100 (S4600). In this case, the notification message may include the query sign Q.

When the user approves the review request included in the notification message (S4910), the chatbot execution unit 340 may output, to a chat window of the user, the identification indicator I corresponding to the query sign Q.

The query sign Q and the identification indicator I may be the same character, symbol, figure, etc. In such a case, the chatbot execution unit 340 may obtain the identification indicator I in a way to copy a message including the query sign Q from the review management system 300 without any change and to paste the message on the chat window of the user terminal 100.

In an embodiment, each of the query sign Q and the identification indicator I may be one of a plurality of pieces of partial information constituting product purchase information or may be a combination of the plurality of pieces of partial information.

The identification indicator I may be a combination of a shopping mall 11, an order number 12, an orderer name 13, etc., for example. Furthermore, the identification indicator I may be a combination of a smile 21, a butterfly 22, a clock 23, etc., for example. Alternatively, the identification indicator I may be a set of combined elements selected among the elements.

In an embodiment, the query sign Q and the identification indicator I may be different characters, symbols, figures, etc. In this case, the identification indicator I previously generated in accordance with the user may be copied to the chat window of the user without any change.

In an embodiment, the generation unit 320 may designate a parameter function for connecting the query sign Q and the identification indicator I. That is, when the query sign Q is exposed to a chat window of the review management system 300, the identification indicator I corresponding thereto is not simply copied in and displayed in the chat window of the user terminal 100, but the parameter function may immediately generate or search for the identification indicator I corresponding to the query sign Q and display the identification indicator I in the chat window of the user terminal 100.

The review management system 300 may inquire about the product order information (S4920), and may generate a list of products whose delivery has been completed (S4930). Thereafter, the review management system 300 transmits the list to the channel of the user (S4940). The user may select a product and upload a review of the selected product (S4950).

The uploaded review may be posted on the review page 600. The review page 600 operates in conjunction with a shopping mall server, that is, the sales server 400, and allows consumers to easily view the review when the customers visit the shopping mall and select the product.

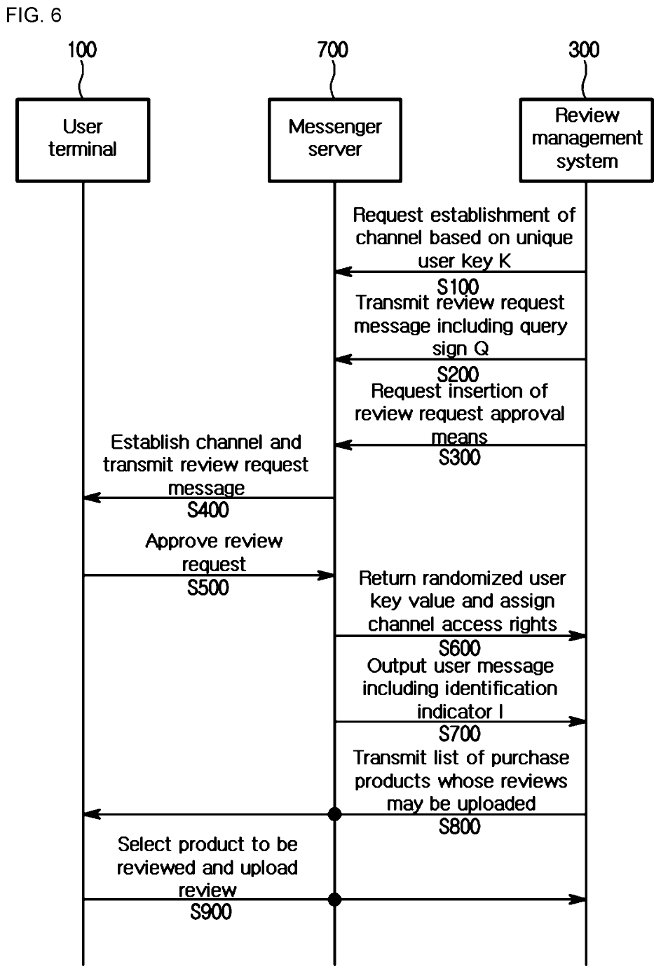

FIG. 6 is a diagram illustrating a process of exchanging, by the review management system according to the embodiment of FIG. 5, data with the messenger server and the user terminal in order to identify a user.

In an embodiment, a messenger in which a chatbot is executed may randomize a user ID. That is, the messenger may use, as an identification value, a given text string composed of information irrelevant to a user. The review management system 300 may request the messenger server 700 to establish a dialogue channel based on a unique public key K, such as a user ID (S100). This process is a process which may be applied to all messengers.

However, if the messenger server 700 changes the user unique key K into a given identification value and returns the identification value and establishes a channel (S600), a manager of the review management system 300 or the corresponding system cannot specify the user. If the user cannot be specified, it is impossible to request a review upload based on personalized purchase information.

Accordingly, the review management system 300 based on a chatbot according to the embodiment of the present disclosure may previously generate a query sign Q and identification indicator I corresponding to the user, may request the establishment of a channel based on the user unique key K (S100), and may simultaneously transmit a review request message including the query sign Q (S200).

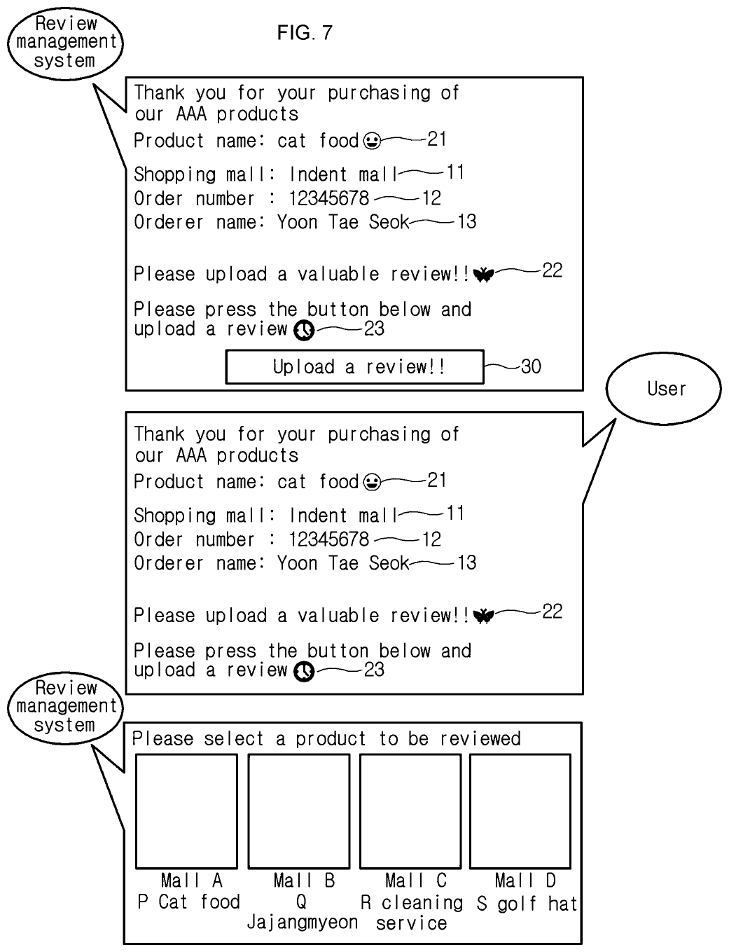

In an embodiment, the review management system 300 may request the establishment of the channel (S100), and may transmit the review request message (S200) and simultaneously request the insertion of “review request approval means” (S300). That is, while transmitting the review request message, the review management system 300 may request the messenger server 700 to output an option, such as an approval button 30 in FIG. 7, along with the review request message.

The approval button 30 requested to be inserted into the review request message by the review management system 300 may be programmed to automatically output a message of a user in response to clicking on the approval button 30, and to output the message including the identification indicator I.

The messenger server 700 may establish a channel between the user and the review management system 300, and may transmit (output) the review request message to the user terminal (S400). The user may approve the review request within the channel (S500).

When the user approves the review request (S500), the review management system 300 may transmit, to the user, a list of purchase products for which review upload is possible. The user can upload a review image or text, etc. by simply selecting (e.g., touching or clicking on) a product to be reviewed.

In an embodiment of the present disclosure, in the case of a messenger in which a user key value is randomized, when the user approves the review request (S500), of the messenger server 700 may return the randomized user key value to the review management system 300, and may assign rights capable of accessing the channel (S600). Thereafter, the messenger server 700 may output the first message of the user including an identification indicator I (S700).

Since the identification indicator I has been output to the first message of the user, the review management system 300 can identify who the user is within the channel by using previously stored relation information among the user, the query sign Q and the identification indicator I.

Accordingly, the review management system 300 may transmit the list of purchase products to the user (S800). The user may simply select (e.g., touching or clicking on) a product to be reviewed and upload a review image or text, etc. (S900).

From a viewpoint of the protection or security reinforcement of personal information, some messengers tend not to share a value for identifying a user. In this case, by selecting a method of inserting an identification indicator I into a user message, who a user is can be accurately identified in a corresponding channel and a personalized service can be provided.

In an embodiment of the present disclosure, in the case of a messenger which does not randomize a user key value, the review management system 300 does not have a difficulty in specifying a user because a process of returning a randomized user key value will not be performed. Accordingly, a process of transmitting, by the review management system 300, the query sign Q and outputting the user message including the identification indicator I may be omitted.

In an embodiment of the present disclosure, if a review request phrase in the form of simple text is used, review request approval means for a user may not be included in the review request message transmitted by the review management system 300. In this case, step S300 of requesting the insertion of the review request approval means in FIG. 6 may be omitted.

In an embodiment of the present disclosure, step S800 of transmitting a list of purchase products whose reviews may be uploaded may be omitted. In this case, the review management system 300 may identify which product corresponds to text, an image or a moving picture uploaded by a user, and may upload the review on the review page 600. In this case, the review management system 300 does not need to transmit the list of purchase products to the user. The user can upload review data without a process of selecting a product whose review is to be uploaded.

FIG. 7 is a diagram illustrating a part of a chatbot interface according to an embodiment of the present disclosure.

The chatbot of the review management system 300 may establish a channel based on detailed information, such as a telephone number of a user. That is, in a step of transmitting the first message, who the user is has been identified.

However, an identification value of the user is randomized and appears from the moment when the user starts answer the first message. Therefore, if the review management system 300 is configured to output a query sign Q to a system-side message and an identification indicator I to a user-side message, while a dialogue is subsequently performed (i.e., while the channel is maintained), who the user is can be always specified based on the presence of the identification indicator I within the channel.

If the user wants to upload a review, the user may touch a review upload button, that is, the approval button 30. As soon as the review upload button is touched, a programmed message is output to the message window of the user. The shopping mall 11, the order number 12, the orderer name 13, the smile 21, the butterfly 22, and the clock 23, that is, identification indicators I, may be displayed in the message window of the user. Such a method is one of methods pre-programmed in the chatbot. The review management system 300 may recognize such identification indicators I (or a selective combination of the identification indicators), and may specify a corresponding user by using a database every dialogue within a corresponding channel.

After the user is specified as described above, the chatbot may inquire about order information of products that have been inquired about meanwhile and whose delivery has been completed, and may show, to the user, a list of products whose reviews will be uploaded. As illustrated in FIG. 7, reviews of all products can be uploaded in one channel regardless of the sources of the products purchased by a specific user, such as P cat food purchased in a mall A, Q Jajangmyeon purchased in a mall B, R cleaning service purchased in a mall C, and S golf hat purchased in a mall D.

The method of managing a review based on a chatbot according to an embodiment of the present disclosure may be executed by an application (the application may include a platform basically installed in a terminal, a program included in an operating system, etc.) basically installed in a terminal, and may be executed by an application (i.e., a program) directly installed in a master terminal by a user through an app store server, an application or an application provision server, such as a web server related to a corresponding service. In this sense, the method of managing a review based on a chatbot according to an embodiment of the present disclosure may be implemented as an application (i.e., a program) basically installed in a terminal or directly installed by a user, and may be recorded on a computer-readable recording medium, such as a terminal.

Although the present disclosure has been described as described above, a person having ordinary knowledge in the art to which the present disclosure pertains will recognize that the present disclosure may be implemented in other forms without departing from the technical spirit and essential characteristic of the present disclosure.

The scope of the present disclosure will be defined by the claims, but a configuration directly derived from the writing of the claims and all changes or modified forms derived from an equivalent configuration thereof should be construed as belonging to the scope of rights of the present disclosure.

1: A review management system based on a chatbot, comprising:
an information reception unit configured to receive product purchase information of a user from at least one sales server;
a checking unit configured to monitor delivery information of the purchased product in real time;
a chatbot execution unit configured to establish a channel through which a chatbot is able to communicate with the user when a preset period elapses after the checking unit checks delivery completion, and request the user to upload a review of a corresponding product; and
a review posting unit configured to post a review on a review page when the user uploads the review on the channel,
wherein the product comprises a service, the delivery information is service execution information when the product is a service, and the delivery completion is service execution completion.

2: The review management system of claim 1, further comprising a generation unit configured to obtain user information from the product purchase information and generate a query sign that specifies the user and an identification indicator corresponding to the query sign,
wherein the chatbot execution unit identifies the user based on the identification indicator, and requests the user to upload the review of the corresponding product through the chatbot by outputting the query sign and the identification indicator to a channel of a user terminal when the preset period elapses after the checking unit checks the delivery completion.

3: The review management system of claim 2, wherein the chatbot execution unit
directly or indirectly transmits, to the channel, a notification message comprising the query sign when the checking unit checks the delivery completion, wherein the chatbot execution unit outputs a message of the user comprising the identification indicator when the message of the user is input to the channel after the notification message is transmitted to the channel, and
requests the user to upload the review of the corresponding product by inquiring about the product purchase information of the user corresponding to the identification indicator.

4: The review management system of claim 2, wherein the identification indicator is identical with the query sign.

5: The review management system of claim 2, wherein each of the query sign and the identification indicator is any one of a plurality of pieces of partial information constituting the product purchase information or a combination of the plurality of pieces of partial information.

6: A method of managing a review based on a chatbot, comprising:
receiving product purchase information of a user from at least one sales server;
monitoring delivery information in real time;
establishing a channel through which a chatbot is able to communicate with the user when a preset period elapses after delivery completion is checked, and requesting the user to upload a review of a corresponding product; and
posting a review on a review page when the user uploads the review on the channel,
wherein the product comprises a service, the delivery information is service execution information when the product is a service, and the delivery completion is service execution completion.

7: The method of claim 6, further comprising obtaining user information from the product purchase information and generating a query sign that specifies the user and an identification indicator corresponding to the query sign,
wherein the requesting of the user to upload the review comprises identifying the user based on the identification indicator and requesting the user to upload the review of the corresponding product through the chatbot by outputting the query sign and the identification indicator to a channel of a user terminal when the preset period elapses after the delivery completion is checked.

8: The method of claim 7, wherein the requesting of the user to upload the review comprises:
directly or indirectly transmitting, to the channel of the user terminal, a notification message comprising the query sign when the preset period elapses after the delivery completion is checked;
outputting a message of the user comprising the identification indicator when the message of the user is input to the channel after the notification message is transmitted to the user terminal; and
requesting the user to upload the review of the corresponding product by inquiring about the product purchase information of the user corresponding to the identification indicator.

9: The method of claim 8, wherein the identification indicator is identical with the query sign.

10: The method of claim 8, wherein each of the query sign and the identification indicator is any one of a plurality of pieces of partial information constituting the product purchase information or a combination of the plurality of pieces of partial information.
